(19) United States
(12) Patent Application Publication
(10) Pub. No.: US 2026/0100111 A1
(43) Pub. Date: Apr. 9, 2026

(54) GAMING SYSTEMS AND METHODS HAVING INDEPENDENT SPECIAL FEATURE TRIGGER SYMBOLS

(71) Applicant: Aristocrat Technologies, Inc., Las Vegas, NV (US)

(72) Inventors: Nathan Warms, Austin, TX (US); Erick Ching, Cedar Park, TX (US); Rogelio Decasa, JR., Renton, WA (US); Jennifer Mizzi, JR., Ewa Beach, HI (US); Shayer Waseem Shaik, Palam Vihar (IN)

(21) Appl. No.: 18/905,683

(22) Filed: Oct. 3, 2024

(51) Int. Cl. G07F 17/34; G07F 17/32

(52) U.S. Cl. CPC G07F 17/34; G07F 17/3213

(57) ABSTRACT

A gaming system includes a processor that initiates a base game including a matrix having a plurality of symbol positions. The processor causes display of an array of symbols populated in the symbol positions. Each symbol in the array of symbols is randomly selected from a reel strip. A first reel strip associated with a first symbol position includes a first special symbol and a second reel strip associated with a second symbol position includes a second special symbol. A feature game trigger condition is satisfied in response to at least one of: i) the first special symbol being displayed in the first symbol position and ii) the second special symbol being displayed in the second symbol position. The first special symbol is a trigger for a first feature game and the second special symbol is a trigger for a second feature game.

### TECHNICAL FIELD

The field of disclosure relates generally to electronic gaming devices, systems and methods that provide independent special feature trigger symbols during game play.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out. ”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, a gaming system includes a processor and a memory storing instructions thereon. When executed, the instructions cause the processor to initiate a base game, the base game including a matrix having a plurality of symbol positions, the plurality of symbol positions including a first symbol position and a second symbol position. The instructions further cause the processor to cause display of an outcome of the base game, the outcome including an array of symbols populated in the plurality of symbol positions, each symbol in the array of symbols being randomly selected from a reel strip of a plurality of reel strips, wherein a first reel strip associated with the first symbol position includes a first special symbol and a second reel strip associated with the second symbol position includes a second special symbol. The instructions further cause the processor to determine that a feature game trigger condition is satisfied in response to at least one of: i) the first special symbol being displayed in the first symbol position and ii) the second special symbol being displayed in the second symbol position. The instructions further cause the processor to identify a feature game to be played in response to the feature game trigger condition being satisfied, wherein the first special symbol is a trigger for a first feature game and the second special symbol is a trigger for a second feature game different from the first feature game.

In another aspect, a non-transitory computer-readable media is provided containing instructions embodied thereon. When executed, the instructions cause a processor to initiate a base game, the base game including a matrix having a plurality of symbol positions, the plurality of symbol positions including a first symbol position and a second symbol position. The instructions further cause the processor to cause display of an outcome of the base game, the outcome including an array of symbols populated in the plurality of symbol positions, each symbol in the array of symbols being randomly selected from a reel strip of a plurality of reel strips, wherein a first reel strip associated with the first symbol position includes a first special symbol and a second reel strip associated with the second symbol position includes a second special symbol. The instructions further cause the processor to determine that a feature game trigger condition is satisfied in response to at least one of: i) the first special symbol being displayed in the first symbol position and ii) the second special symbol being displayed in the second symbol position. The instructions further cause the processor to identify a feature game to be played in response to the feature game trigger condition being satisfied, wherein the first special symbol is a trigger for a first feature game and the second special symbol is a trigger for a second feature game different from the first feature game.

In yet another aspect, a method of implementing a game is provided. The method includes initiating a base game, the base game including a matrix having a plurality of symbol positions, the plurality of symbol positions including a first symbol position and a second symbol position. The method further includes causing display of an outcome of the base game, the outcome including an array of symbols populated in the plurality of symbol positions, each symbol in the array of symbols being randomly selected from a reel strip of a plurality of reel strips, wherein a first reel strip associated with the first symbol position includes a first special symbol and a second reel strip associated with the second symbol position includes a second special symbol. The method further includes determining that a feature game trigger condition is satisfied in response to at least one of: i) the first special symbol being displayed in the first symbol position and ii) the second special symbol being displayed in the second symbol position. The method further includes identifying a feature game to be played in response to the feature game trigger condition being satisfied, wherein the first special symbol is a trigger for a first feature game and the second special symbol is a trigger for a second feature game different from the first feature game.

### BRIEF DESCRIPTION OF THE DRAWINGS

FIG. 1 is an exemplary diagram showing several gaming machines networked with various gaming related servers.

FIG. 2A is a block diagram showing various functional elements of an exemplary gaming machine.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flow chart of a process for executing electronic game play for display to a user on a gaming device, such as a gaming device similar to the gaming device of FIG. 1.

FIG. 5 is an example screen display showing display of a base game according to the process of FIG. 4, prior to initiating a first game instance.

FIG. 6 is an example screen display showing display of an outcome of a first game instance of the base game shown in FIG. 5.

FIG. 7 is an example screen display showing an additional display of the outcome of the first game instance shown in FIG. 6.

FIG. 8 is an example screen display showing display of an outcome of a second game instance of the base game shown in FIG. 5.

FIG. 9 is an example screen display showing an additional display of the outcome of the second game instance shown in FIG. 8.

FIG. 10 is an example screen display showing display of an outcome of a third game instance of the base game shown in FIG. 5.

FIG. 11 is an example screen display showing an additional display of the outcome of the third game instance shown in FIG. 10.

FIG. 12 is an example screen display showing display of a first feature game according to the process of FIG. 4, prior to initiating a first game instance.

FIG. 13 is an example screen display showing display of an outcome of a first game instance of the first feature game shown in FIG. 12.

FIG. 14 is an example screen display showing display of an outcome of a first game instance of a second feature game according to the process of FIG. 4.

FIG. 15 is an example screen display showing display of a spin of a second game instance of the second feature game shown in FIG. 14.

FIG. 16 is an example screen display showing display of an outcome of a first game instance of a third feature game according to the process of FIG. 4.

FIG. 17 is an example screen display showing display of an outcome of a fourth game instance of the base game shown in FIG. 5.

FIG. 18 is an example screen display showing an additional display of the outcome of the fourth game instance shown in FIG. 17.

FIG. 19 is an example screen display showing a display message displayed during play of the base game according to the process of FIG. 4.

### DETAILED DESCRIPTION

Described herein are systems and methods for feature games that include independently landing special feature trigger symbols in electronic gaming. An electronic game is provided including symbols provided within a plurality of symbol positions. For each spin of the game, the symbol positions are populated based on a simulated spinning of reels to include symbols such as combinable base symbols, cash-on-reel (“COR”) symbols, and one or more of the special symbols. The special symbols may each be associated with a feature game enhancement and act as a trigger for the game to enter a free spins feature game having the game enhancement associated with the special trigger symbol. As an example, where a first special symbol is landed, a randomized lookup may be performed to determine whether to launch into a first feature game having a multiplier enhancement. Where a second special symbol is landed, a randomized lookup may be performed to determine whether to launch into a second feature game having a different enhancement, such as an added free spins enhancement. The special symbols may evaluate as a “WILD” symbol and “unlock” the COR symbols and trigger awarding of the credit award associated with the COR symbols.

In some embodiments, the game is an “individual reels” game, in which each symbol position of the matrix is associated with at least one or more reels and is populated based on a randomized lookup of the one or more associated reels. That is, the symbols in a given column may each be populated from a different reel strip. In some such embodiments, the special symbols are each provided on a single reel strip such that the first special symbol may land only in a first symbol position and the second special symbol may land only in a second symbol position. As a result, in such embodiments, only a single one of the first special symbol or a single one of the second special position may land in any given outcome of the base game. Such configurations provided an improved control over a return-to-player (“RTP”) of the game and reduce processing requirements to execute the game according to a controlled RTP. For example, where only a single instance of a special symbol type may land in a given outcome, the “costs” associated with that outcome (e.g., feature game costs, COR unlocking costs, WILD combination costs, etc.) are controllable by a lookup of a single table listing the probability that the special symbol will land.

The technical problems addressed herein include: (i) inability of known systems to provide display variance in collecting triggering symbols associated with different feature games and/or unlocking COR symbols; (ii) inability of known systems to provide different types of triggering symbols that are associated with both different feature games and unlocking COR symbols; (iii) inability of known systems to provide a combined feature game that includes combined game enhancements of other feature games and is triggered by a combination of different special trigger symbols; (iv) inefficient use of computer resources in known gaming systems at least because of burdensome processing requirements when determining displayed game outcomes; and (v) lack of processing availability and speed in known gaming systems at least because of the burdensome processing requirements.

The resulting technical effect and/or technical benefits achieved herein include at least one of: (i) ability to provide display variance in collecting triggering symbols associated with different feature games and/or unlocking COR symbols; (ii) ability to provide different types of triggering symbols that are associated with both different feature games and unlocking COR symbols; (iii) ability to provide a combined feature game that includes combined game enhancements of other feature games and is triggered by a combination of different special trigger symbols; (iv) improved efficiency in the use of computer resources by performing a lookup of individual reels for populating individual symbol positions in displayed game outcomes; and (vi) improved processing availability and speed at least because of the improved efficiency in the use of computer resources.

The description provided herein includes certain examples and exemplary use cases. It should be understood that these examples and use cases are included herein for illustrative purposes, and these examples and use cases should not be taken to limit the present disclosure. The systems and methods described herein may be used in many other use cases.

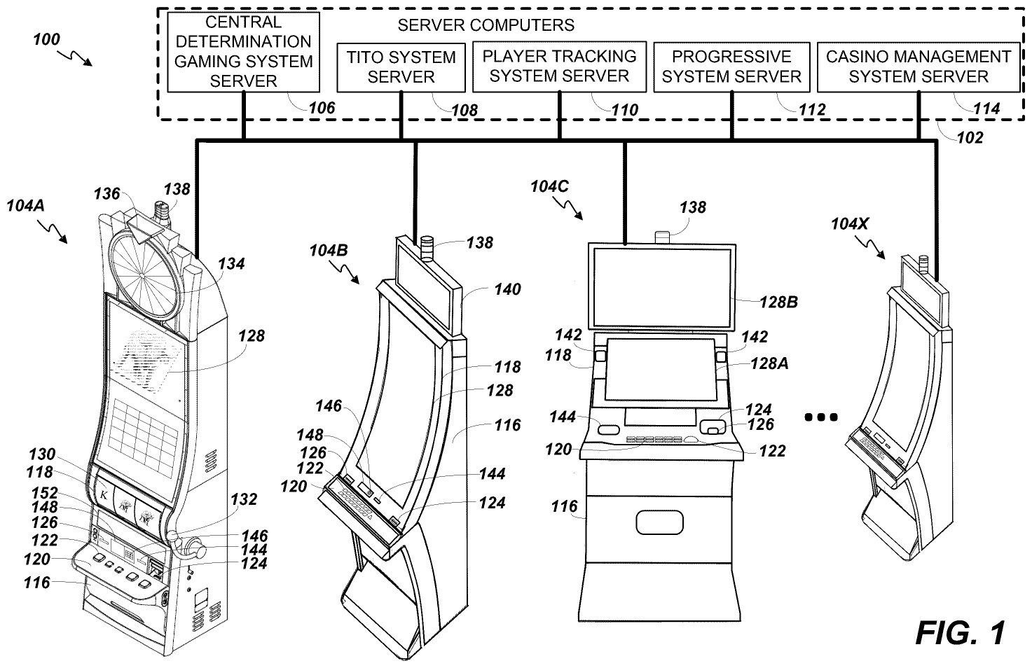

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

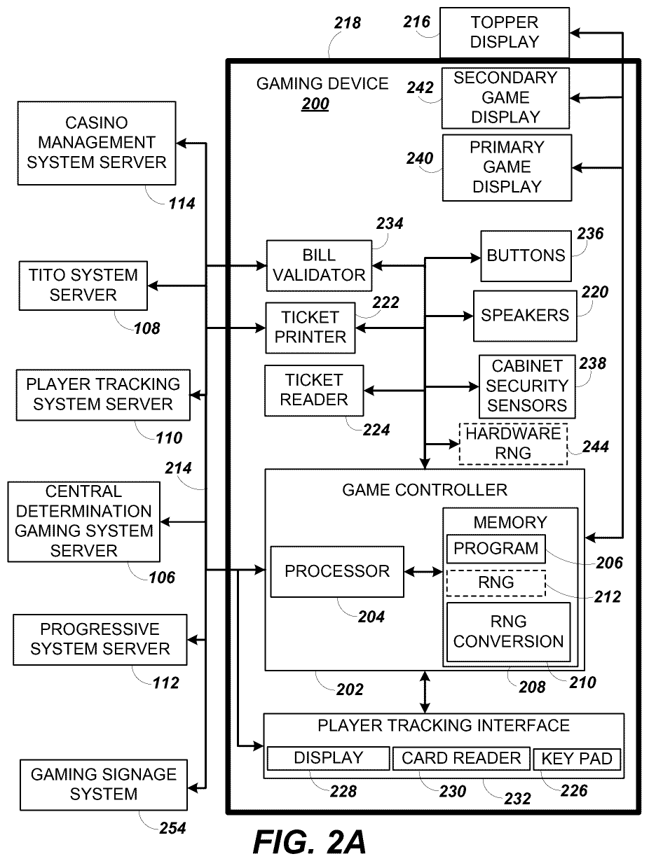

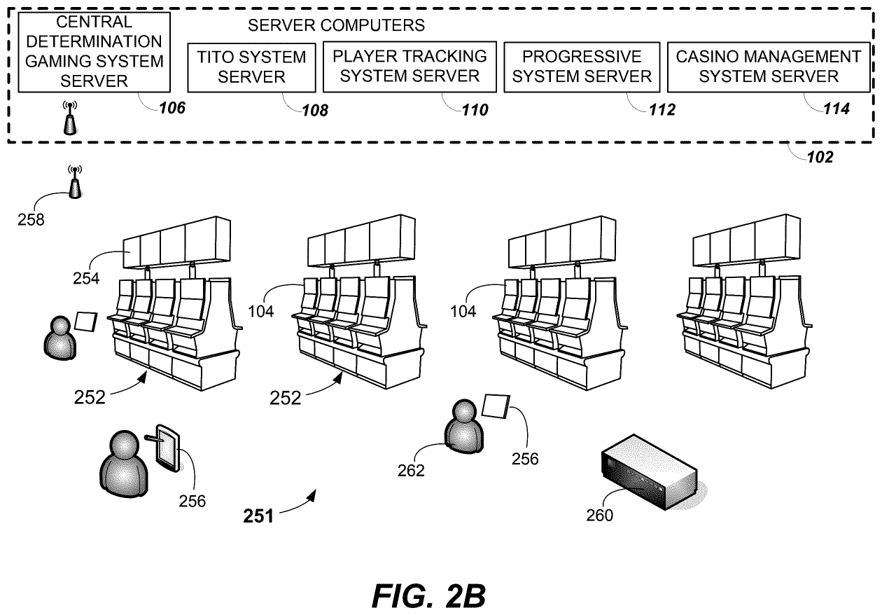

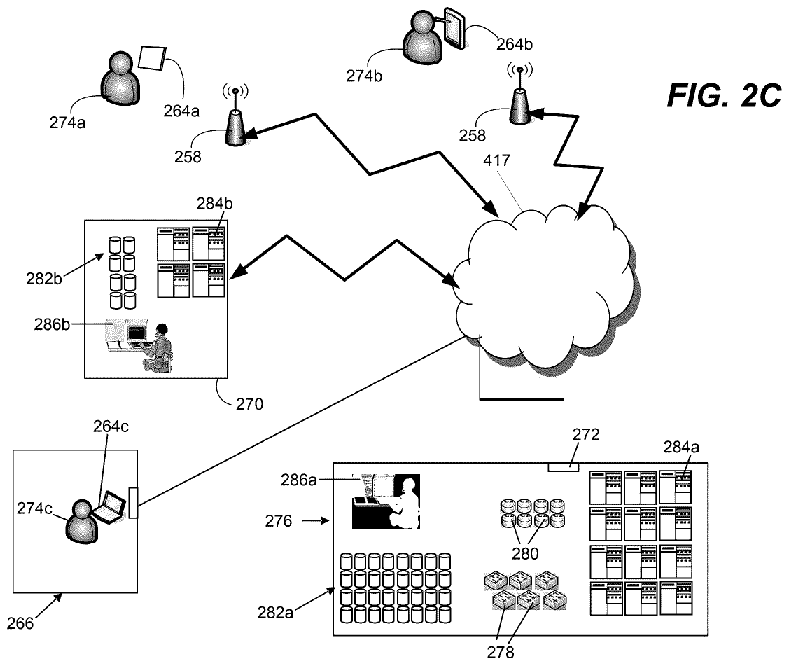

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

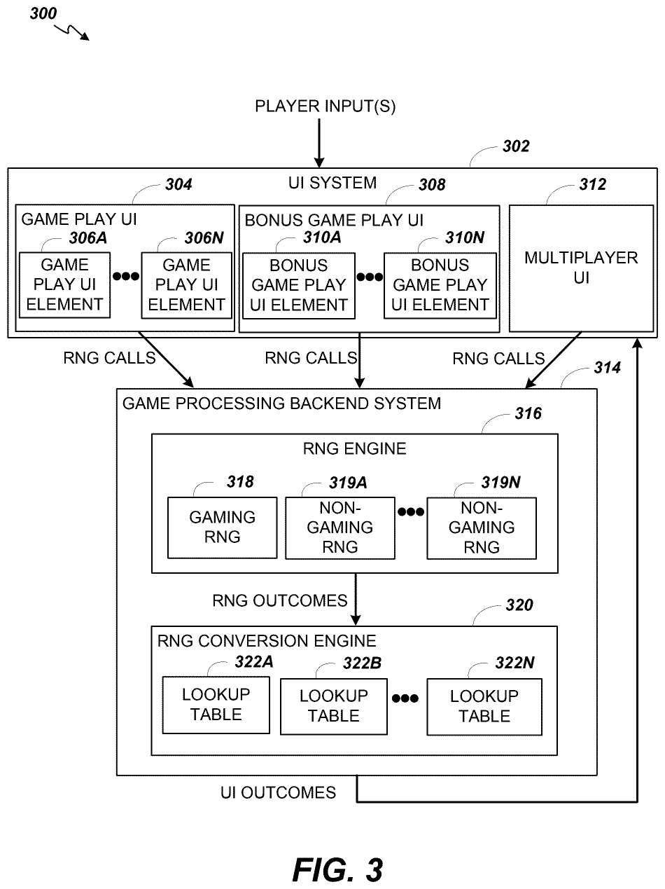

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

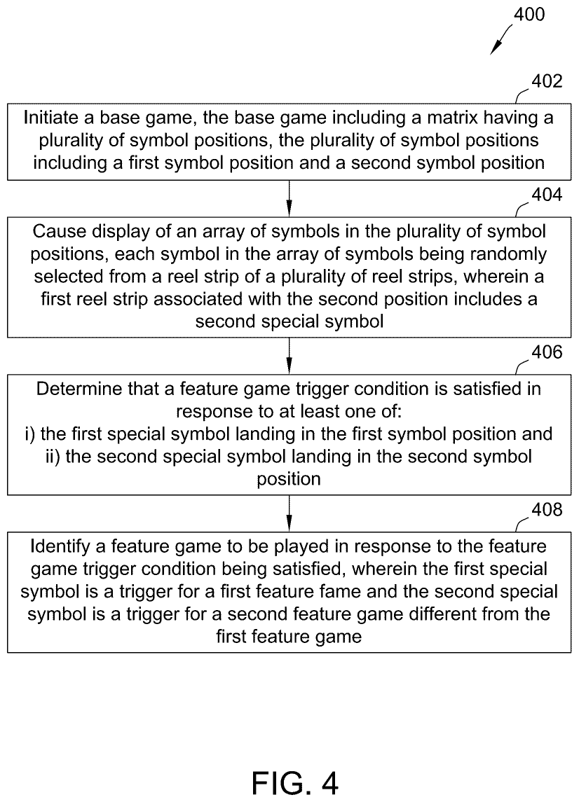

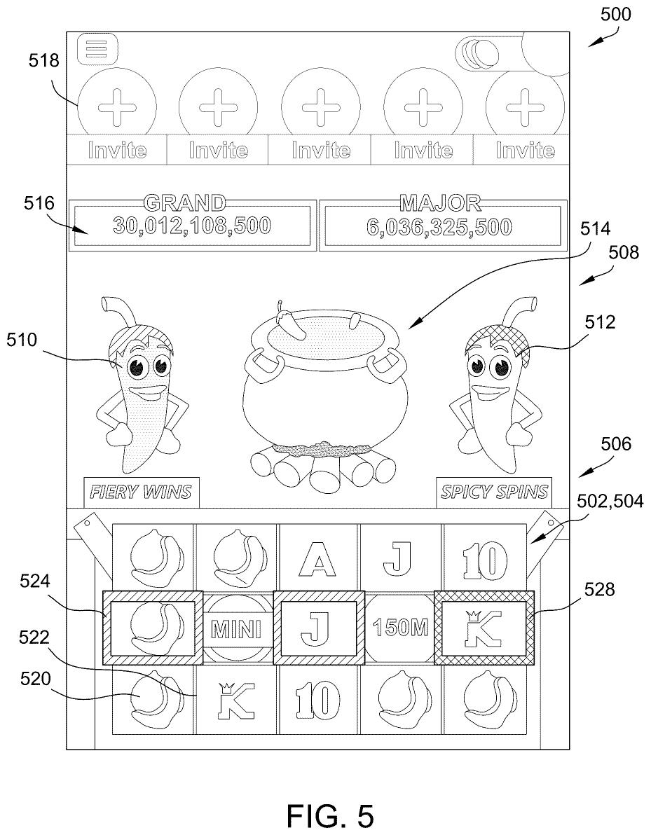

FIG. 4 is a flow chart of an example process 400 for executing electronic game play for display to a user. FIG. 5 shows a schematic of an example game display 500, which may be displayed by mobile gaming devices 256 or on any gaming device similar to gaming devices 104A-104X, shown in FIG. 1. The game display 500 of FIG. 5 shows a display provided during a base game prior to initiating a first spin (alternatively referred to herein as “game instance”) of the base game.

In the example embodiment, the game includes a base game and a plurality of feature games which may be initiated based on play of the base game. The base game is an electronic slot game in which a plurality of symbol positions are displayed to a user. The processor 204 configures play of the game based on a set of instructions stored in the memory 208.

Referring to FIG. 4, at a first step 402, the base game is initiated. The base game includes a matrix 502 having a plurality of symbol positions 504. Referring to FIG. 5, game display 500 includes a primary game display area 506 and a secondary game display area 508. The primary game display area 506 includes the matrix 502 that includes a plurality of symbol positions 504 arranged in a plurality of columns and a plurality of rows. In the example embodiment, matrix 502 is a three row by five column grid of symbol positions. In other embodiments the base game matrix 502 may include more or fewer columns and/or rows. The matrix 502 includes a plurality of symbol display positions 504 for presenting symbols (and/or symbol combinations).

In the example embodiment, secondary game display area 508 includes metamorphic indicators 510, 512, 514, jackpot indicators 516, and a social indicator 518. The jackpot indicators 516 display a current state of one or more jackpots (e.g., Grand and Major) that may be won during play of the base game. The social indicator 518 displays player avatars of additional players participating in a social feature of the game, described in greater detail below.

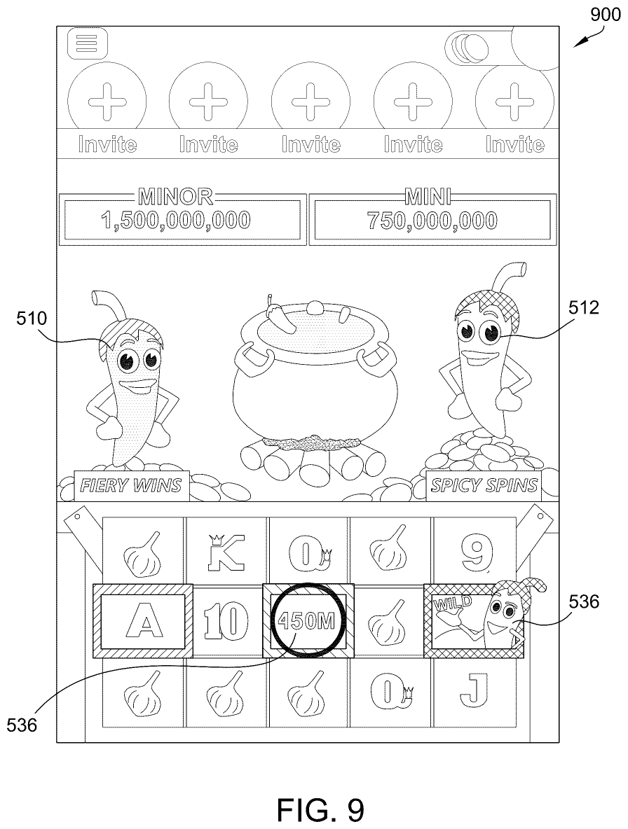

The metamorphic indicators include a first metamorphic indicator 510, a second metamorphic indicator 512, and a third metamorphic indicator 514. The first and second metamorphic indicators 510, 512 each provide a visual representation related to one or more feature games. For example, the first metamorphic indicator 510 is associated with a first feature game and the second metamorphic indicator 512 is associated with a second feature game. In the example, the first metamorphic indicator 510 is a red chili-pepper and the second metamorphic indicator 512 is a green chili-pepper. During game play in response to one or more metamorphic triggers, such as a corresponding special symbol occurring in the base game outcome, the metamorphic indicators 510, 512 may change to provide a visual representation of progress since the associated feature games were last triggered. In the example embodiment, the visual representation of progress is growing a stack of coins on which the chili-peppers are positioned, as shown in FIG. 9 for example.

In the example embodiment, the third metamorphic indicator 514 provides a visual representation related to a social feature of the electronic game. The third metamorphic 514 indicator may provide an indication of a status of a communal pot that may be distributed amongst a group of active players participating in the social feature, as described in greater detail below. In the example of FIG. 5, the third metamorphic indicator 514 is a boiling stew pot, though any suitable graphic may be used.

As shown in FIG. 5, a plurality of symbols are displayed in the symbol positions of the matrix 502. The symbols may include graphics based symbols 520 (e.g., the rose shown in FIG. 5) and one or more hierarchical symbol sets 522 (e.g., the card deck 10-Ace symbols shown in FIG. 5). In other embodiments any suitable symbols may be used. During game play, credits may be awarded to the player by combinations of symbols formed in the outcome. In the example embodiment, combinations of symbols in at least one of each of the first three columns evaluate to a credit award. Different combinations of different symbols may be associated with different awards. For example, an outcome including at least one of the “Rose” symbol in each of the first four columns may evaluate to a higher credit award compared to an outcome including at least one of the “Rose” symbol in only each of the first three columns.

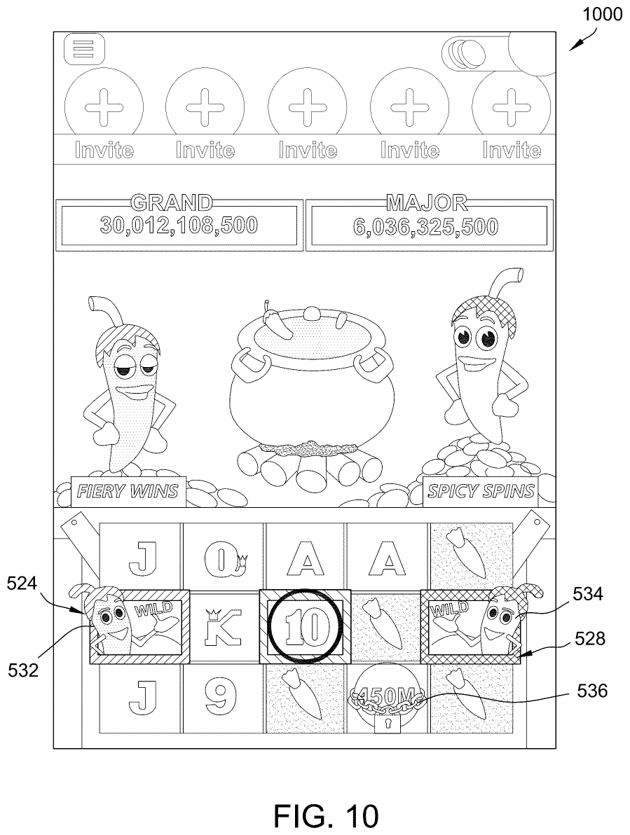

As shown in the example embodiment, the plurality of symbol positions 504 include a first symbol position 524 and a second symbol position 528, alternatively referred to herein as a first and second “special symbol” positions. The first symbol position 524 and second symbol position 528 are each framed by a respective fixed boundary 530. The fixed boundary 530 may be colored in correspondence with a color of special symbols 532, 534 (shown in FIG. 10) that may land in the respective positions 524, 528 and/or the metamorphic indicators 510, 512. For example, in the example embodiment, the fixed boundary 530 of the first symbol position 524 has a red color, corresponding to the red chili-pepper, and the second symbol position 528 has a green color, corresponding to the green chili-pepper.

Referring back to FIG. 4, process 400 further includes causing 402 display of an array of symbols in the plurality of symbol positions 504. In the example embodiment, each symbol in the array of symbols is randomly selected from a reel strip of a plurality of reel strips. Specifically, referring to FIG. 5., the memory 208 stores a plurality of reel strips each including a plurality of symbols thereon. A lookup of the reel strips is performed using an RNG output to determine symbols that are to be populated into the symbol positions 504 for the base game outcome. The lookup may identify a “stopping position” of the reel strip and the symbol in the stopping position may be used to populate one or more symbol positions of the matrix.

In the example embodiment, the base game is an “individual reels” game, in which each of the symbols are populated based on a reel that is associated with the corresponding symbol position. For example, the memory 208 stores at least one reel strip for each symbol position in the matrix 502 (i.e., at least fifteen reel strips that are each associated with one of the fifteen symbol positions 504). One or more outputs of the RNG may be obtained to perform the lookups of each of the reels for each available symbol position. In some embodiments, a different RNG output is generated for each of the fifteen lookups of the reels used to populate the symbol positions 504. The lookup identifies a single symbol (e.g., at the stopping position of the reel strip determined based on the lookup), which is used to populate the corresponding symbol position. In the example embodiment, a spinning of symbols on the respective reel strips is displayed in each of the symbol positions of the matrix 502.

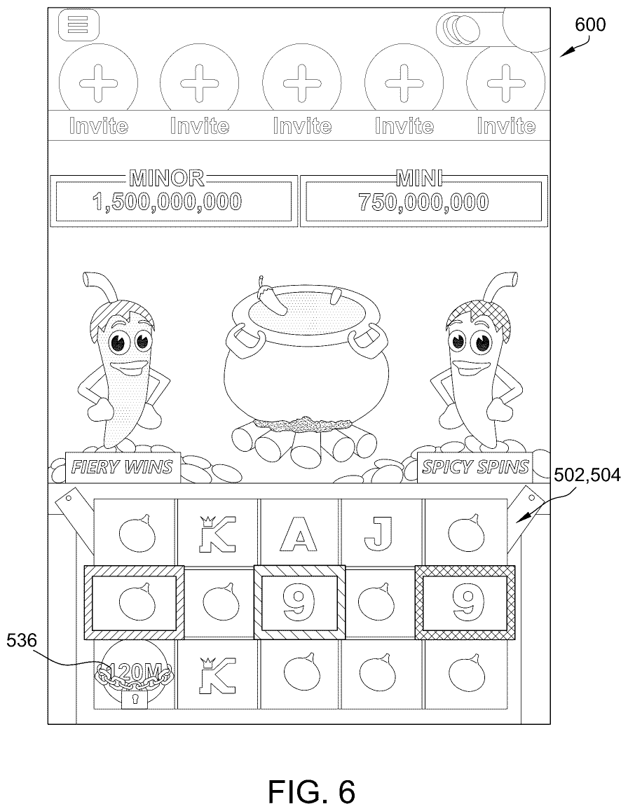

FIG. 6 shows a display 600 of an outcome of the base game, with each of the symbol positions 504 being populated with a corresponding symbol. In the example embodiment, reels further include COR symbols 536. The COR symbols 536 each include a credit value associated with the respective COR symbol 536 that are displayed within the COR symbols 536. For example, in FIG. 6, a value of “120 million” credits is displayed in the COR symbol 536. In the example embodiment, the credit values for the COR symbols 536 are fixed on the reels, although in other embodiments they may be dynamic (i.e., randomly assigned using weighting). In the example embodiment, the COR symbols 536 are displayed as “locked” and the credit values are awarded in response to when at least one of the special symbols 532, 524 (shown in FIG. 10) are landed in the game outcome. In the example of FIG. 6, no special symbols have landed in the first or second symbol positions 504 and the credit value for the COR symbol 536 is not awarded.

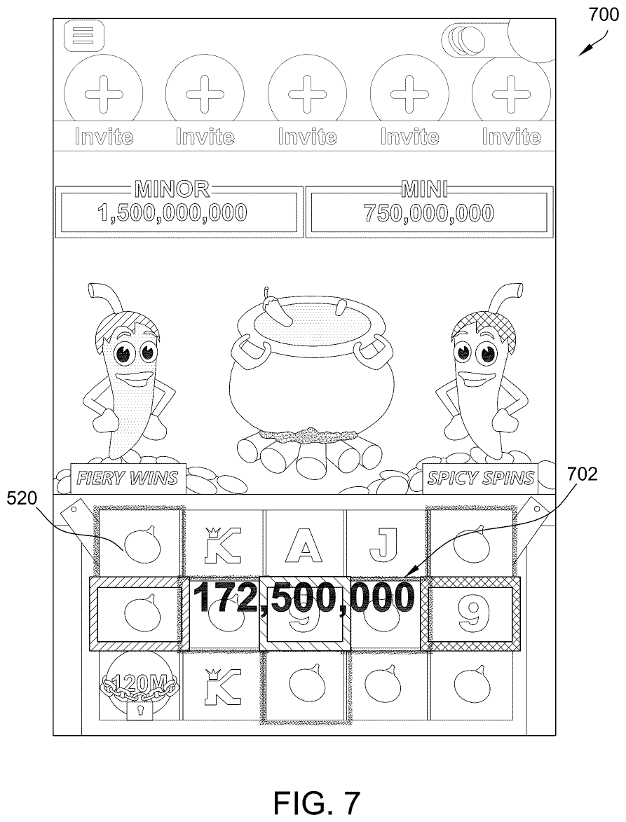

FIG. 7 shows another display 700 of the outcome including a credit award message 702, indicating that a credit win is awarded based on the combination of symbols 520.

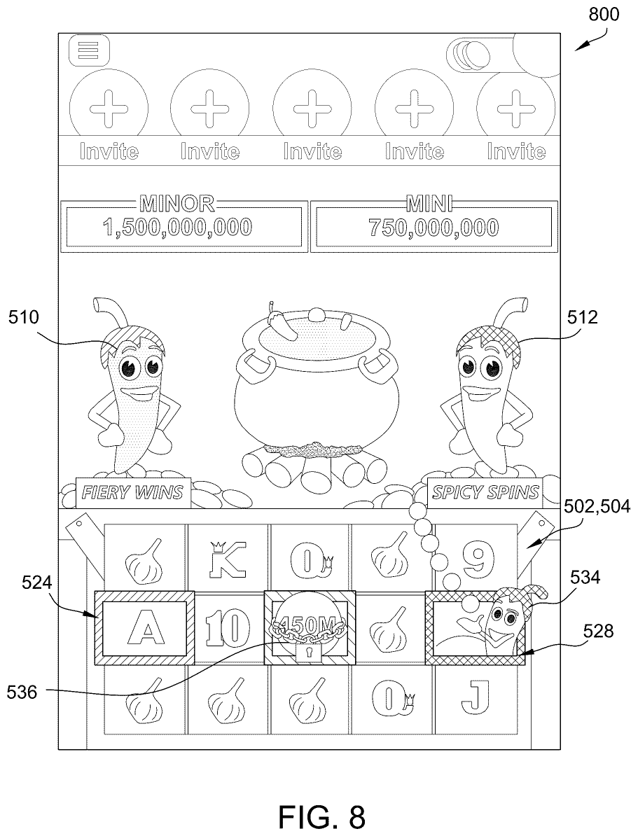

FIG. 8 shows another display 800 of an outcome of another spin of the base game. In the outcome of FIG. 8, the second special symbol 534 is landed. In the example embodiment, the reel strip for the first symbol position 524 includes one or more first special symbols 532, shown in FIG. 10, and the reel strip for the second symbol position 528 includes one or more of the second special symbols 534. The reel strips for the remaining symbol positions 504 of the matrix 502 do not include either the first special symbol 532 or the second special symbol 534. Thus, the first special symbol 532 may only land in the first symbol position 524 and the second special symbol 534 may only land in the second symbol position 528. In the example embodiment, the first and second special symbols 532, 534 are independent in that they are displayed in outcomes (i.e., landed) based on independent determinations. In the example embodiment, the special symbols 532, 534 are each evaluated as a “WILD” symbol and may be treated as any suitable symbol for purposes of determining symbol combinations. For example, referring to FIG. 8, a winning combination of five columns of symbols (e.g., five garlic symbols) is formed based on the second special symbol 534 landing in the fifth column.

In the example embodiment, in response to the special symbols 532, 534 landing in the game outcome, processor 204 determines whether a feature trigger condition is satisfied. In the example embodiment, the feature trigger condition includes the landing of one or more of the special symbols 532, 534 and a lookup of one or more weighted tables, using an RNG output, to determine whether a feature game should be initiated. In response to the second special symbol 534 landing, a lookup of a weighted table associated with a second feature game is performed to determine whether the feature should be initiated.

If the processor 204 determines that the feature game is not initiated based on the lookup, as shown in FIG. 8, one or more additional lookups may be performed to determine whether to display a metamorphic feature associated with the landed special symbol 534 and the corresponding metamorphic indicator 512. In the example of FIG. 8, the metamorphic feature is displayed as a transfer of coins from the second special symbol 534 to the second metamorphic indicator.

FIG. 9 shows another display 900 of the game outcome of FIG. 8. As shown in FIG. 9, the metamorphic indicator 512 is changed by increasing a size of the pile of coins under the chili-pepper of the second metamorphic indicator 512, while the first metamorphic indicator 510 is unchanged, as the first special symbol 532 (shown in FIG. 10) did not land in the outcome. Additionally, the credit value for the COR symbol 536 is awarded in response to the landing of the second special symbol 534 and the “lock” on the COR symbol 536 is removed.

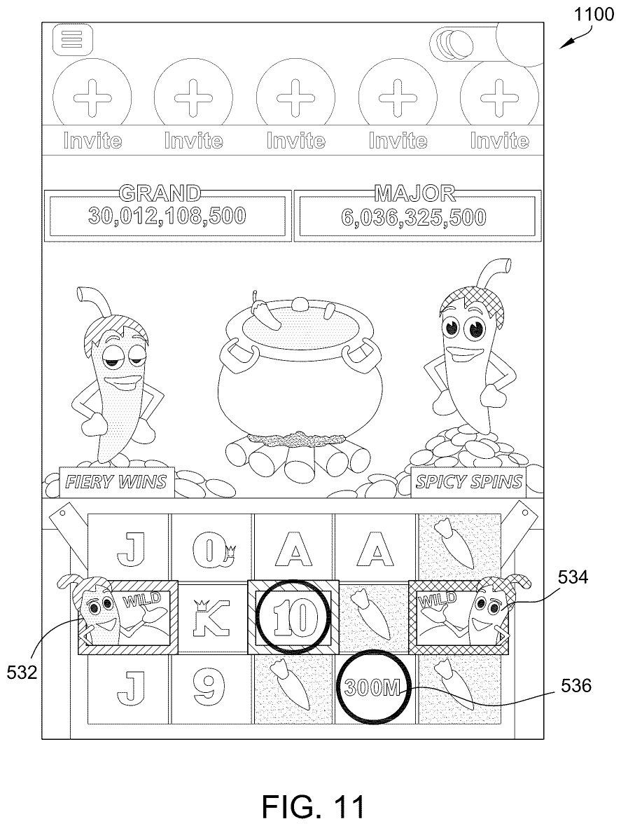

FIG. 10 shows another display 1000 of another outcome of another spin of the base game. As shown in FIG. 10, the first special symbol 532 is landed in the first symbol position 524 and the second special symbol 534 is landed in the second symbol position 528. As shown in FIG. 11, in response to both the first special symbol 532 and the second special symbol 534 landing, the COR symbol 536 is unlocked and an award enhancement is applied to the COR symbol 536. In the example embodiment, the award enhancement includes applying a multiplier (e.g., 2×) to the credit value of the COR symbol 536, increasing the awarded credit value from “150M” credits to “300M” credits. In other embodiments, any suitable award enhancements may be used.

Referring back to FIG. 4, process 400 further includes determining 406 that a feature game trigger condition is satisfied in response to at least one of: i) the first special symbol 532 landing in the first symbol position 524 and ii) the second special symbol 534 landing in the second symbol position 528. Process 400 further includes identifying a feature game to be played in response to the feature game trigger condition being satisfied, wherein the first special symbol 532 is a trigger for a first feature game and the second special symbol 534 is a trigger for a second feature game different from the first feature game. In the example embodiment, memory 208 stores weighted tables associated with each of the first feature game and the second feature game and a lookup of the weighted tables is performed in response to the corresponding trigger symbol 532, 524 landing in the outcome.

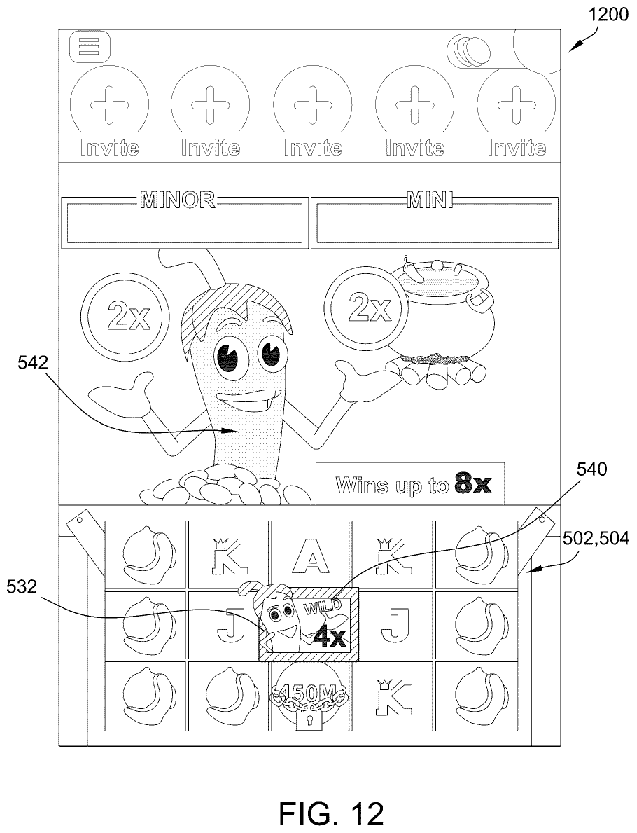

FIG. 12 shows a display 1200 of a game instance of the first feature game. In the example embodiment, the first feature game is a “free spins” feature game, in which additional wagers are not needed for each spin of the feature game. The first feature game includes a matrix 502 of symbol positions 504 that is substantially similar to the matrix 502 used in the base game, except as otherwise described herein. Specifically, matrix 502 is a three by five matrix of symbol positions and outcomes are generated by performing lookups of individual reels associated with each of the symbol positions 504 of the matrix 502. However, unlike the base game, matrix 502 includes at least one sticky symbol position 540. The first special symbol 532 persists in the sticky symbol position 540 for outcomes for each spin of the first feature game. In the example embodiment, the sticky symbol position 540 is centrally located within the matrix 502, though in other embodiments, the sticky symbol position 540 may include any symbol position of the matrix 502.

In the example embodiment, prior to each spin of the feature game, a random lookup of a weighted table is performed to determine whether to award a game enhancement for the spin of the feature game and/or a magnitude of the game enhancement. As shown in FIG. 12, the game enhancement is a multiplier that is applied to credit awards resulting from each outcome of the first feature game, though in other embodiments, any suitable game enhancement may be used. The weighted table may include a plurality of multipliers (e.g., 2×, 4×, 8×, etc.) and the lookup may identify which multiplier is applied for one or more spins of the first feature game. In the example embodiment, a multiplier is determined for each spin of the feature game and the weighted table is structured such that at least the 2× multiplier is applied for each spin. The lookups for the game enhancement for each spin may be performed using the same weighted table.

In the example embodiment, the first feature game includes a first feature metamorphic indicator 542 that provides a visual indication of the game enhancement awarded for each spin of the feature game. The first feature metamorphic indicator 542 is a red chili-pepper having coins with “2×” multiplier indicators thereon. The persistent special symbol 532 may include an initial “2×” indicator therein prior to each spin of the first feature game, and the first feature metamorphic indicator 542 may supplement the “2×” indicator, when the “4×” or “8×” multipliers are awarded, by transferring one or more of the “2×” coins to the persistent special symbol 532.

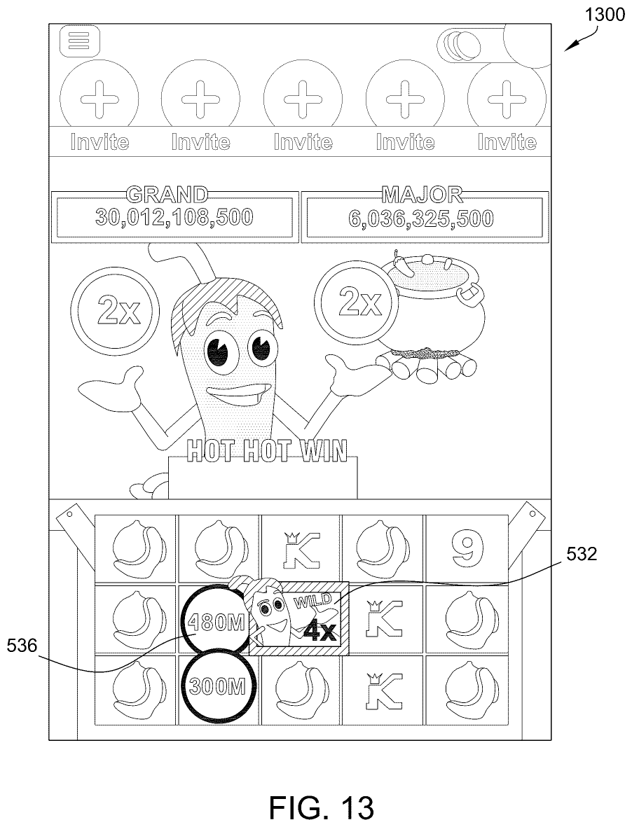

FIG. 13 shows a display 1300 of an outcome of the game instance of the first feature game shown in FIG. 12. As shown in FIG. 13, the game enhancement of a “4×” multiplier is awarded and applied to any credit wins. Additionally, each of the COR symbols 536 in the outcomes of the first feature game are unlocked, as the first special symbol 532 persists in the outcomes.

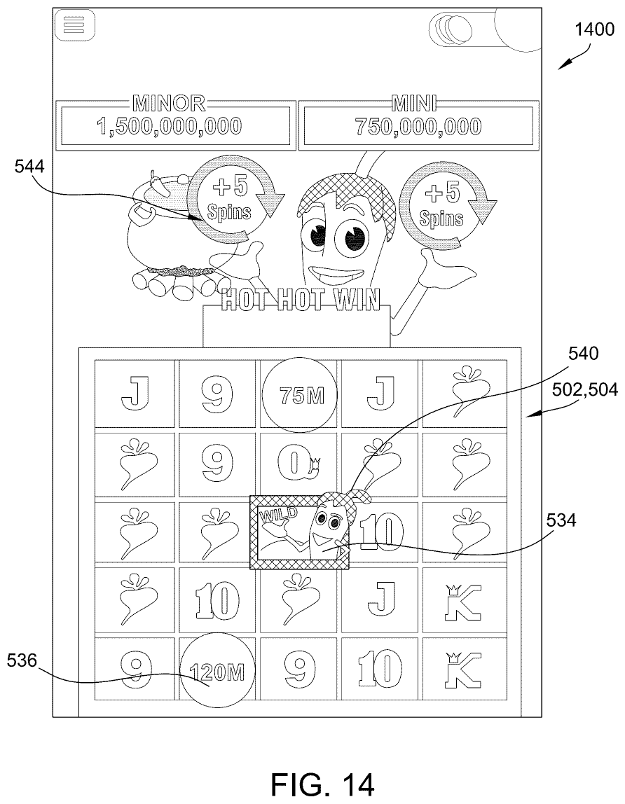

FIG. 14 shows a display 1400 of an outcome of a game instance of a second feature game. The second feature game is a free spins game, similar to the first feature game, except the second feature game includes a different sized matrix 502 and a game enhancement that is different from the first feature game. The second feature game is initiated in response to the second special symbol 534 landing in the outcome of the base game and further in response to a lookup of a weighted table associated with the second feature game.

In the example embodiment, the second feature game includes a matrix 502 having 25 symbol positions arranged in five rows and five columns. That is, the matrix 502 includes additional rows relative to the base game and the first feature game. The additional symbol positions in the matrix increases the probability of forming winning symbol combinations. The matrix 502 includes a sticky symbol position 540 centrally located in the matrix 502 and the second special symbol 534 persists in the sticky symbol position 540 in substantially the same manner as described with respect to the first feature game. For example, the second special symbol 534 is evaluated as a “WILD” symbol and unlocks any COR symbols 536 in outcomes of the second feature game.

In the example embodiment, the game enhancement for the second feature game is an “increased free spins” enhancement. The second feature game initially starts with a base number of free spins (e.g., five free spins). Memory 208 stores a free spins counter, which is decremented for each spin of the second feature game. After the number of free spins reaches zero, the second feature game is ended and gameplay is returned to the base game.

In response to each spin, a lookup of a weighted table is performed to determine whether to increment the number of free spins. Rows of the weighted table may be populated with a number of spins to award, such as zero, five, or ten in the example embodiment. If the lookup identifies a number of free spins to be added, the free spins counter is increased based on the lookup. In some embodiments, the memory 208 may store a plurality of lookup tables for determining the free spins game enhancement and the processor selects a lookup table from the plurality of lookup tables based on one or more states of the game. The lookup tables may include different probabilities for awarding free spins relative to one another. In the example embodiment, prior to performing the game enhancement lookup, the processor selects one of the weighted tables based on a number of spins that have occurred and/or that have been added for the current round of the second feature game. For example, where the current number of spins having occurred are less than and/or equal to a predefined threshold, a first lookup table may be used for the lookup. If the current number of spins is greater than and/or equal to the predefined threshold, a second lookup table having lower probabilities relative to the first table for awarding free spins may be used. As a result, the number of free spins and RTP associated with the second feature game may be controlled by limiting the probability of abnormally large numbers of free spins being awarded in any given round of the second feature game. In other embodiments, the same weighted table may be used for each spin of the second feature game, irrespective of the number of free spins played and/or awarded.

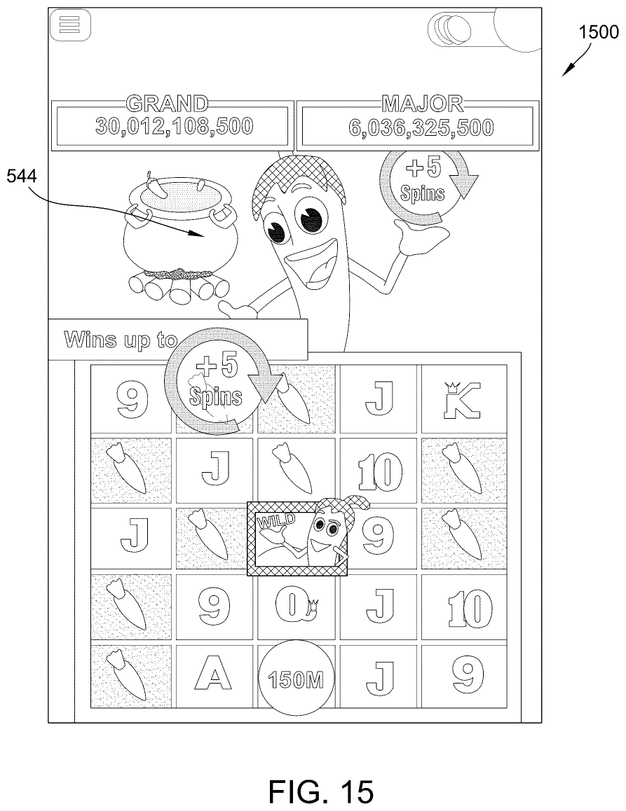

In response to a free spins increase game enhancement being awarded, a visual indication is displayed to the player. Display 1400 includes a second feature metamorphic indicator 544, which indicates whether the number of free spins is increased. In the example embodiment, the second feature metamorphic indicator 544 includes the green chili-pepper holding two “+5 spins” indicators. As shown in FIG. 15, when additional spins are awarded, one or more of the “+5 spins” indicators are moved by the second feature metamorphic indicator 544. Additionally, a spins remaining counter (not shown) on display 1400 is updated to reflect the added free spins.

Referring back to FIG. 10, in the example embodiment, where both the first special symbol 532 and the second special symbol 534 are landed in the outcome of the base game, a lookup of a weighted table may be performed to determine whether to initiate a third feature game, alternatively referred to herein as a “combination” feature game. The lookup for determining whether to initiate the combination feature game may be additional or alternative to lookups for determining whether to launch the first or second feature games. In the example embodiment, when both the first special symbol 532 and the second special symbol 534 are landed, as shown in FIG. 10, the processor first determines whether the combination feature is triggered based on the lookup of the weighted table. If the combination feature is not triggered, the processor determines whether only the first feature game or only the second feature game are triggered based on lookups of respective weighted tables associated with the first feature game and the second feature game.

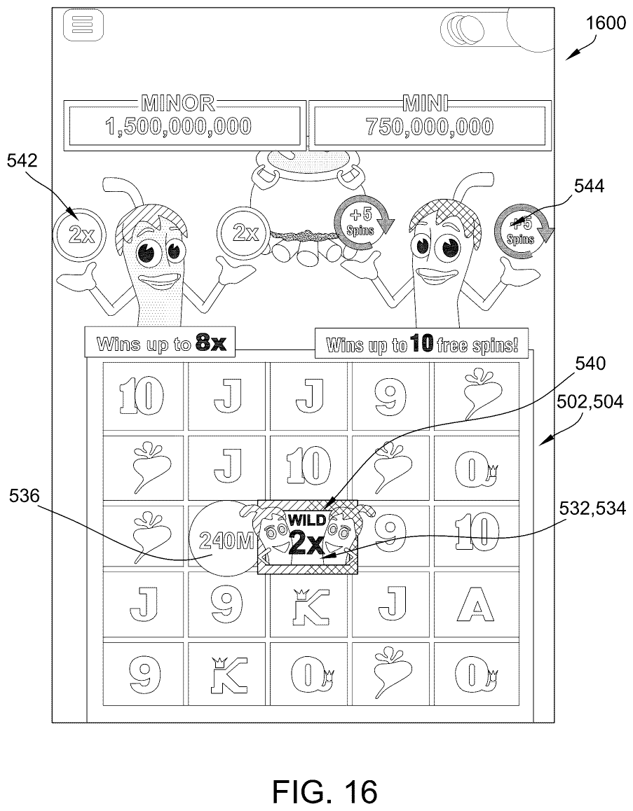

FIG. 16 shows an outcome for a game instance of the combination feature game. In the example embodiment, the combination feature game is configured as a combination of the first feature game and the second feature game. For example, the combination feature game includes each of the game enhancements of both the first feature game and the second feature game (i.e., award multipliers and added free spins). A sticky symbol position 540 is provided at a center of the matrix 502 and each of the first special symbol 532 and the second special symbol 534 are positioned within the sticky symbol position 540 for each spin of the combination feature game. During each spin, the processor determines both a multiplier to be applied to the credit award outcomes and whether any additional free spins are to be added. The determinations may be made by performing lookups of the same weighted tables used for the first feature game and the second feature game. Additionally, the matrix 502 is increased by two additional rows for the combination feature game, similar to the second feature game. In other embodiments, the third feature game may incorporate different game enhancements and/or a portion of the game enhancements of the first feature game or the second feature game. For example, in some embodiments the matrix 502 size is not increased. Additionally, similar to the first and second feature games, each of the COR symbols 536 are unlocked and awarded when landed for each spin of the combination feature game.

In the example embodiment, the combination feature game includes both the first feature metamorphic indicator 542 and the second feature metamorphic indicator 544. The first feature metamorphic indicator 542 and the second feature metamorphic indicator 544 provide a visual indication of the awarding of the game enhancements associated with the respective metamorphic indicators in substantially the same manner as described with respect to the first feature game and the second feature game.

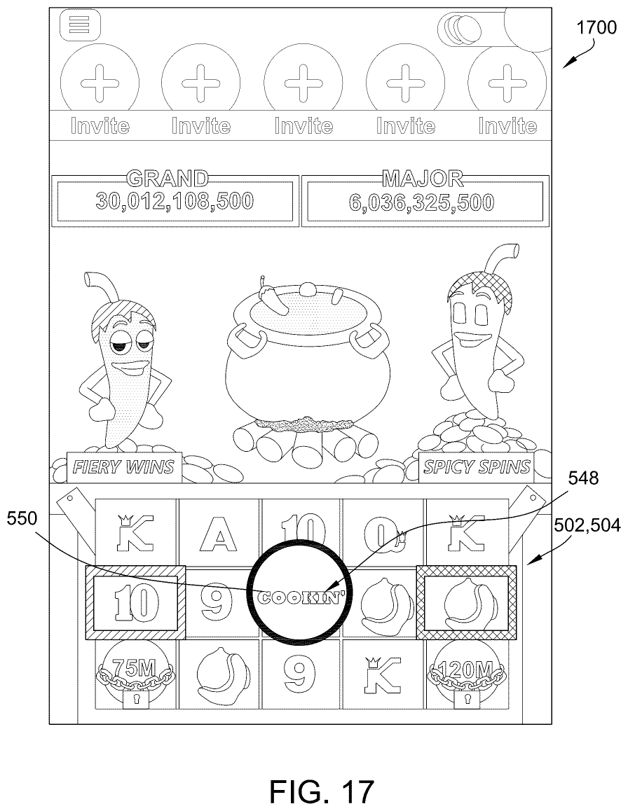

FIG. 17 shows a display 1700 of another game outcome of the base game. The matrix 502 further includes a third symbol position 548 associated with a social feature of the game. The third symbol position 548 is positioned centrally in the matrix 502 (i.e., in the second row and third column). As shown in FIG. 17, the outcome includes display of a third special symbol 550 in the third symbol position 548. The third special symbol 550 is provided on a third reel associated with the third symbol position 548. In the example embodiment, the third special symbol 550 is only provided on the third reel, such that the third special symbol 550 may only land in the third symbol position 548. The third special symbol 550 is associated with a social enhancement of the game, in which a plurality of players winnings are contributed to a communal pot.

In the example embodiment, the third special symbol 550 is a trigger symbol for entering a player into the social feature. In response to the third special symbol 550 occurring in the outcome, a matching of the players winnings on the activating spin are contributed to the communal pot. As an example, if the player is awarded 100 credits on a spin in which the third special symbol is landed, 100 credits may be awarded to the player and an additional 100 credits may be added to the communal pot. In other embodiments, the player may contribute some or a portion of their individual award to the communal pot. In some embodiments, a random multiplier is determined (e.g., by performing a random lookup of a weighted table) and applied to the wins of the activating spins.

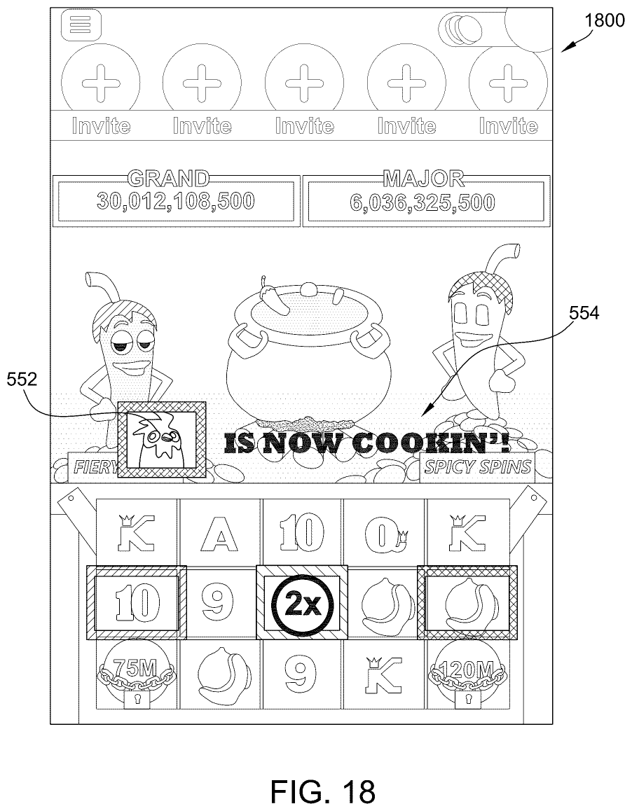

In the example embodiment, when the player is “active” in the social feature, they are made eligible to win a share of the credits from the communal pot. As shown in the display 1800 of FIG. 18, each of the players active in the social feature may be linked with a player avatar 552 and, when the player is made active in the social feature, a common display message 554 is provided to other active players in the social feature.

In the example embodiment, a payout to each of the players active in the social feature is made in response to a social award trigger condition being satisfied. The social award trigger condition may include, a predetermined amount of contributions to the communal pot, a predetermined number of contributions to the communal pot, and/or a predetermined number of contributions from each player active in the social feature to the communal pot. In the example embodiment, the payout is determined by equally dividing the total credit amount of the communal pot evenly amongst the players that are active when the social award trigger condition is satisfied. That is, the communal pot is divided evenly amongst the players irrespective of player contribution to the communal pot. In other embodiments, different shares of the communal pot may be distributed based on factors such as, a length of time and/or spins a player is active in the social feature, a player being the player to satisfy the social award trigger condition, a player's contributions to the communal pot, etc.

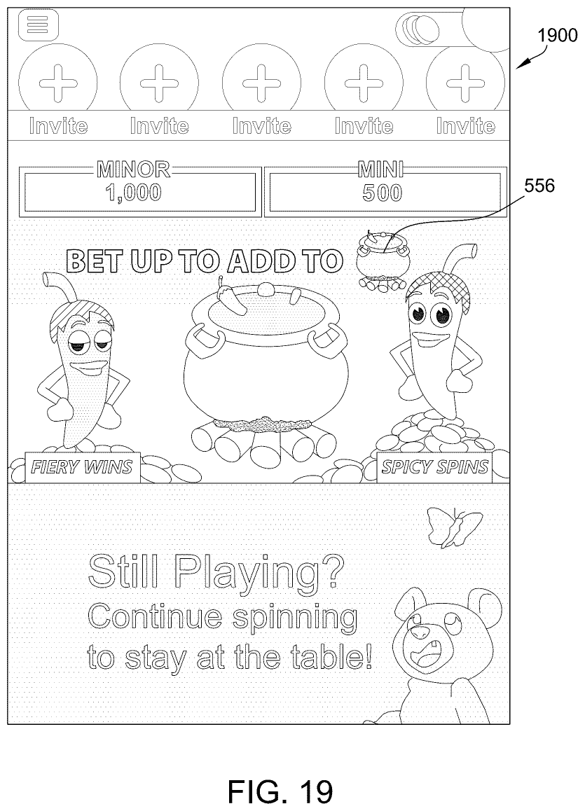

In the example embodiment, a bet condition (also referred to as a “contribution condition”) is stored and restricts eligibility of players to participate in and/or be active in the social feature. In the example embodiment, the bet condition is a minimum wager threshold and to be eligible to participate in and/or be active in the social feature, a player must place wagers for each spin that are at or above the minimum wager threshold. If a wager is placed that is below the minimum wager threshold, the player is made ineligible for the social feature by at least one of switching the reel associated with the third symbol position with a different reel that does not include the third special symbol 550 (shown in FIG. 18) and/or removing the player from active status in the social feature. As shown in the display 1900 of FIG. 19, in some embodiments, a warning message 556 is displayed to the player indicating that an increased bet is required to participate in the social feature.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A gaming system comprising:
a processor; and
a memory storing instructions thereon wherein the instructions when executed by the processor, cause the processor to:
initiate a base game, the base game including a matrix having a plurality of symbol positions, the plurality of symbol positions including a first symbol position and a second symbol position;
cause display of an outcome of the base game, the outcome including an array of symbols populated in the plurality of symbol positions, each symbol in the array of symbols being randomly selected from a reel strip of a plurality of reel strips, wherein a first reel strip associated with the first symbol position includes a first special symbol and a second reel strip associated with the second symbol position includes a second special symbol;
determine that a feature game trigger condition is satisfied in response to at least one of: i) the first special symbol being displayed in the first symbol position and ii) the second special symbol being displayed in the second symbol position; and
identify a feature game to be played in response to the feature game trigger condition being satisfied, wherein the first special symbol is a trigger for a first feature game and the second special symbol is a trigger for a second feature game different from the first feature game.

2. The gaming system of claim 1, wherein the memory further stores a first weighted table associated with the first feature game and a second weighted table associated with the second feature game, wherein the instructions, when executed by the processor further cause the processor to:
determine that the first special symbol is displayed in the first symbol position;
generate an output of a random number generator (“RNG”); and
perform a lookup of the first weighted table using the RNG output to determine that the feature game trigger condition is satisfied; and
identify the first feature game as the feature game to be played in response to the feature game trigger being satisfied.

3. The gaming system of claim 1, wherein each symbol position of the plurality of symbol positions is associated with a unique reel strip of the plurality of reel strips.

4. The gaming system of claim 1, wherein the first feature game includes a first game enhancement and the second feature game includes a second game enhancement that is different from the first game enhancement.

5. The gaming system of claim 4, wherein the first game enhancement includes a multiplier feature and the second game enhancement includes an added free spins feature.

6. The gaming system of claim 5, wherein the second game enhancement further includes a change in size of the matrix.

7. The gaming system of claim 4, wherein the instructions, when executed by the processor, further cause the processor to:
initiate a third feature game in response to both the first special symbol being displayed in the first symbol position and the second special symbol being displayed in the second symbol position, wherein the third feature game includes both the first game enhancement and the second game enhancement.

8. The gaming system of claim 1, wherein the instructions, when executed, further cause the processor to:
cause display of a first metamorphic indicator and a second metamorphic indicator, wherein the first metamorphic indicator is associated with the first feature game and the second metamorphic indicator is associated with the second feature game;
cause the first metamorphic indicator to change in response to the first special symbol being displayed in the first symbol position; and
cause the second metamorphic indicator to change in response to the second special symbol being displayed in the second symbol position.

9. The gaming system of claim 1, wherein the plurality of symbol positions include a third symbol position and wherein a third reel strip associated with a third symbol position includes a third special symbol, wherein the instructions, when executed, further cause the processor to:
activate a social feature in response to the third special symbol being displayed in the third symbol position.

10. The gaming system of claim 9, wherein the social feature includes a communal pot linked with a plurality of active players on a plurality of gaming devices, and wherein the communal pot is incremented in response to one or more of the players landing the third special symbol in the third symbol position, wherein the instructions, when executed, further cause the processor to:
determine whether a social feature award trigger condition is satisfied based on the outcome of the base game; and
in response to the determination, provide a portion of the communal pot to each active player of the plurality of active players.

11. The gaming system of claim 10, wherein the portion is an equal portion for each active player of the plurality of active players.

12. The gaming system of claim 9, wherein the instructions, when executed, further cause the processor to:
receive a wager from a user-input device; and
determine whether the wager is greater than or equal to a minimum wager threshold for the social feature, wherein the social feature is activated based on the determination.

13. A non-transitory computer-readable media containing instructions embodied thereon which, when executed by a processor, cause the processor to:
initiate a base game, the base game including a matrix having a plurality of symbol positions, the plurality of symbol positions including a first symbol position and a second symbol position;
cause display of an outcome of the base game, the outcome including an array of symbols populated in the plurality of symbol positions, each symbol in the array of symbols being randomly selected from a reel strip of a plurality of reel strips, wherein a first reel strip associated with the first symbol position includes a first special symbol and a second reel strip associated with the second symbol position includes a second special symbol;
determine that a feature game trigger condition is satisfied in response to at least one of: i) the first special symbol being displayed in the first symbol position and ii) the second special symbol being displayed in the second symbol position; and
identify a feature game to be played in response to the feature game trigger condition being satisfied, wherein the first special symbol is a trigger for a first feature game and the second special symbol is a trigger for a second feature game different from the first feature game.

14. The non-transitory computer-readable media of claim 13, wherein the media further stores a first weighted table associated with the first feature game and a second weighted table associated with the second feature game, wherein the instructions, when executed by the processor further cause the processor to:
determine that the first special symbol is landed in the first symbol position;
generate an output of a random number generator (“RNG”); and
perform a lookup of the first weighted table using the RNG output to determine that the feature game trigger condition is satisfied; and
identify the first feature game as the feature game to be played in response to the feature game trigger being satisfied.

15. The non-transitory computer-readable media of claim 13, wherein each symbol position of the plurality of symbol positions is associated with a unique reel strip of the plurality of reel strips.

16. The non-transitory computer-readable media of claim 13, wherein the first feature game includes a first game enhancement and the second feature game includes a second game enhancement that is different from the first game enhancement.

17. The non-transitory computer-readable media of claim 16, wherein the first game enhancement includes a multiplier feature and the second game enhancement includes an added free spins feature.

18. The non-transitory computer-readable media of claim 16, wherein the instructions, when executed by the processor, further cause the processor to:
initiate a third feature game in response to both the first special symbol being displayed in the first symbol position and the second special symbol being displayed in the second symbol position, wherein the third feature game includes both the first game enhancement and the second game enhancement.

19. A method of implementing a game comprising:
initiating a base game, the base game including a matrix having a plurality of symbol positions, the plurality of symbol positions including a first symbol position and a second symbol position;
causing display of an outcome of the base game, the outcome including an array of symbols populated in the plurality of symbol positions, each symbol in the array of symbols being randomly selected from a reel strip of a plurality of reel strips, wherein a first reel strip associated with the first symbol position includes a first special symbol and a second reel strip associated with the second symbol position includes a second special symbol;
determining that a feature game trigger condition is satisfied in response to at least one of: i) the first special symbol being displayed in the first symbol position and ii) the second special symbol being displayed in the second symbol position; and
identifying a feature game to be played in response to the feature game trigger condition being satisfied, wherein the first special symbol is a trigger for a first feature game and the second special symbol is a trigger for a second feature game different from the first feature game.

20. The method of claim 19 further comprising:
storing, on a memory, a first weighted table associated with the first feature game and a second weighted table associated with the second feature game;
determining that the first special symbol is landed in the first symbol position;
generating an output of a random number generator (“RNG”); and
performing a lookup of the first weighted table using the RNG output to determine that the feature game trigger condition is satisfied; and
identifying the first feature game as the feature game to be played in response to the feature game trigger being satisfied.
